(19) United States
(12) Patent Application Publication
(10) Pub. No.: US 2024/0049755 A1
(43) Pub. Date: Feb. 15, 2024

(54) PLANT-BASED VEGAN SIMULATED EGG

(71) Applicant: Float Foods PTE Ltd, Singapore (SG)

(72) Inventors: Vinita M. Choolani, Singapore (SG); Mathilde Laura Bancillon, Singapore (SG); Keshav Raj, Singapore (SG)

(73) Assignee: Float Foods PTE Ltd, Singapore (SG)

(21) Appl. No.: 18/256,288

(22) PCT Filed: Dec. 6, 2021
(86) PCT No.: PCT/SG2021/050757

§ 371 Date: Jun. 7, 2023

(30) Foreign Application Priority Data
Dec. 7, 2020 (SG) 10202012183R
Jul. 8, 2021 (SG) 10202107522S

(51) Int. Cl. A23L 15/00; A23L 7/10; A23L 19/00; A23L 3/36; A23L 11/00; A23J 3/16; A23L 27/00; A23L 5/44

(52) U.S. Cl. CPC A23L 15/35; A23L 7/115; A23L 19/00; A23L 3/36; A23L 11/00; A23J 3/16; A23L 27/84; A23L 5/44

(57) ABSTRACT

The present invention is directed to plant-based vegan simulated egg compositions and methods of producing such compositions. More particularly, the invention provides, for example, vegan simulated egg yolk and/or egg white compositions for producing a fried or poached egg, an omelette, or as a substitute for egg yolks in various foods. In some embodiments the egg yolk comprises beta glucan, to reduce blood cholesterol, and/or the egg white comprises about 10 wt % protein.

### FIELD OF THE INVENTION

The present invention is directed to plant-based vegan simulated egg compositions and methods of producing such compositions. More particularly, the invention provides, for example, vegan simulated egg yolk and/or egg white compositions for producing a fried or poached egg, an omelette, or as a substitute for egg yolks in various foods. In some embodiments the egg yolk comprises beta glucan to reduce blood cholesterol and/or the egg white comprises a similar protein content to a chicken egg white.

### BACKGROUND OF THE INVENTION

It is well known that some characteristics of egg and egg products are often cause for concern, and otherwise impede the ability for some people to consume food products having egg products therein. For example, many individuals may be unable to, or would prefer not to consume egg products due to egg allergies, health concerns associated with cholesterol, culinary preferences (such as a Vegetarian or vegan diet), use of antibiotics and hormones during poultry production, and diseases associated with poultry (such as, for example, bird flu). Additionally, the high cost and/or cost fluctuations in the price of eggs and the contamination by salmonella carried by eggs have also been a concern of food manufacturers.

In addition, the world's ability to provide a growing population with adequate and nutritious food is becoming fragile due to environmental degradation and climate change. In the newer food product group, the nutraceutical and functional food market is one of the fastest-growing food segments.

Covid19 has exacerbated food-safety concerns in Singapore and around the world. Singapore has an urgent need to build its food resilience and security, as a country that imports 74% of its entire supply of eggs. The government has put in place the 30 by 30 initiative, with the aim of putting in place initiatives for the country to produce 30% of its nutritional needs locally by 2030.

There is a need for simulated egg compositions that can be produced locally, and that will mimic, visually and sensorily, animal-derived eggs, particularly avian eggs, more specifically chicken eggs or their components.

### SUMMARY OF THE INVENTION

The present invention is directed to plant-based vegan egg compositions and methods of producing such compositions. More particularly, the invention provides, for example, vegan simulated egg yolk and/or egg white for producing a fried or poached egg, an omelette, or as a substitute for egg yolks in various foods such as baked goods, pasta, sauces and desserts. The invention provides vegan simulated egg compositions having the sensory properties and/or function of chicken yolks and/or whites. In some embodiments the egg yolk comprises beta glucan, preferably provided in oat bran, to reduce blood cholesterol.

In a first aspect of the invention, there is provided a plant-based vegan simulated egg yolk composition comprising the components:
tomatoes or natural orange color such as beta-carotene, canola oil, calcium lactate, chickpeas, turmeric, miso; and
   a) beta-glucan from a grain bran or oat fibre, plant-based emulsifier, natural flavoring and a gum; or
   b) kala namak, aquafaba, mustard, paprika and chilli powder; or
   c) kala namak, aquafaba, mustard and a gum,
wherein the egg yolk has been encapsulated in sodium alginate by reverse-spherification.

Advantageously, the presence of beta glucan in the plant-based vegan simulated egg yolk of a) provides additional health benefits. Beta-glucans have been linked to the reduction of cholesterol and to the prevention of cardiovascular diseases. More particularly, oat bran and barley bran are known as sources of beta glucan that can lower blood cholesterol. Oat bran is a by-product of oat (A vena sativa L.) grain processing. Additionally, recent studies insinuate that oat beta glucans can support gastrointestinal health and assist in weight management by promoting satiety and/or reducing energy intake at meals. An example of a high beta-glucan oat bran is marketed as SWEOAT™ BRAN BG28 XF (Swedish Oat Fiber AB, Sweden) It comprises per 100 g, 52 g dietary fiber, of which 28 g is 8-glucan soluble fiber with a molecular weight >2,000 kDa, 23 g protein and 5 g fat. To produce high beta-glucan oat bran, clean oat groats or rolled oats are ground and the resulting oat flour is separated by sieving, bolting and/or other suitable means into fractions so that the oat bran fraction is not more than 50% of the starting material, and has total β-glucan content of at least 5.5%. Replacing one-to-one the oat bran powder with alternatives such as oat fiber powder or beta glucans from other grain brans, in particular barley beta glucan is viable. However, oat bran powder is preferred because it carries 23% protein and the beta glucans in oat provide scientifically proven health benefits. In some embodiments, the vegan yolk composition comprises oat bran powder in a range of about 1-5 wt %.

Whilst any plant-based emulsifier may be provided in the composition of a), lecithin, is an emulsifier which also has uses as an antioxidant and flavor protector and is preferred in the invention. Lecithin could be provided from sunflower and rapeseed, soy lecithin is preferred as it offers similar health benefits to other types of lecithin and is more easily accessible.

In some embodiments of a), lecithin is the emulsifier.

In some embodiments of a), the vegan yolk composition comprises lecithin in a range of about 0.5-1 wt %.

In some embodiments, the plant-based vegan simulated egg yolk composition comprises: tomatoes in an amount of about 25-35 wt %, canola oil in an amount of about 15-30 wt %, calcium lactate in an amount of about 0.5-3 wt %, chickpeas in an amount of about 5-15 wt %, turmeric in an amount of about 0.1-2 wt %, miso paste in an amount of about 2-7 wt %; and in
a) oat bran powder in an amount of about 1-5 wt %, soy lecithin in an amount of about 0.5-1 wt %, natural flavoring in an amount of about 1-3 wt % and gellan gum in an amount of about 0.05-0.1 wt %; or
b) kala namak in an amount of about 0.5-2.0 wt %, aquafaba in an amount of about 20-30 wt %, mustard in an amount of about 1-5 wt %, paprika in an amount of about 0.4-0.6 wt % and chilli powder in an amount of about 0.1-0.2 wt %; or
c) kala namak in an amount of about 0.5-2.0 wt %, aquafaba in an amount of about 20-30 wt %, mustard in an amount of about 1-5 wt % and xanthan gum in an amount of about 0.05-2 wt %, by weight of said egg yolk composition.

In some embodiments, the plant-based vegan simulated egg yolk composition comprises in:
a) tomatoes in an amount of about 25-30 wt %, canola oil in an amount of about 15-20 wt %, calcium lactate in an amount of about 1-3 wt %, chickpeas in an amount of about 10-15 wt %, turmeric in an amount of about 0.1-0.5 wt %, miso paste in an amount of about 5-7 wt %, oat bran powder in an amount of about 1-5 wt %, soy lecithin in an amount of about 0.5-1 wt %, natural flavoring in an amount of about 1-3 wt %, and gellan gum in an amount of about 0.05-0.1 wt %; or b) tomatoes in an amount of about 25-35 wt %, canola oil in an amount of about 20-30 wt %, calcium lactate in an amount of about 0.5-2 wt %, chickpeas in an amount of about 5-10 wt %, turmeric in an amount of about 0.1-2 wt %, miso paste in an amount of about 2-5 wt %, kala namak in an amount of about 0.5-2.0 wt %, aquafaba in an amount of about 20-30 wt %, mustard in an amount of about 1-5 wt %, paprika in an amount of about 0.4-0.6 wt %, and chilli powder in an amount of about 0.1-0.2 wt %; or
c) tomatoes in an amount of about 25-35 wt %, canola oil in an amount of about 20-30 wt %, calcium lactate in an amount of about 0.5-2 wt %, chickpeas in an amount of about 5-10 wt %, turmeric in an amount of about 0.1-2 wt %, miso paste in an amount of about 2-5 wt %, kala namak in an amount of about 0.5-2.0 wt %, aquafaba in an amount of about 20-30 wt %, mustard in an amount of about 1-5 wt %, and xanthan gum in an amount of about 0.05-2 wt %,
by weight of said egg yolk composition.

In some embodiments of a) of the first aspect, the plant-based vegan simulated egg yolk composition comprises one or more natural flavoring substances for sulphuric note and/or creamy mouthfeel, such as black salt and/or nutritional yeast.

In some embodiments of b) or c) of the first aspect, the canola oil is substituted in whole or in part by another plant oil, such as rapeseed oil, peanut oil, vegetable oil, soya bean oil.

In some embodiments of b) or c) of the first aspect, 10 wt % to 90 wt %, preferably 20 wt % to 60 wt %, of the canola oil is substituted by a rapeseed oil containing phytosterols, such as Vividol® T oil. Akoplanet RSO 100-17100-17 oil may also be used as a substitute. Vividol® T oil is a fat blend based on pine phyto-sterols and rapeseed oil and was obtained from AAK SG Pte Ltd., Singapore 13856.

Akoplanet RSO 100-17100-17 oil is refined and pressed canola oil obtained from AAK SG Pte Ltd., Singapore 13856.

In some embodiments of b) or c) of the first aspect, the mustard is selected from the group comprising Dijon mustard, English mustard and whole grain mustard, preferably Dijon mustard. in some embodiments, the plant-based vegan simulated egg yolk composition further comprises one or more coloring agents. Suitable examples include apocarotenal (IUPAC ID: (2E,4E,6E,8E,10E,12E,14E, 16E)-2,6,11,15-tetramethyl-17-(2,6,6-trimethylcyclohexen-1-yl)heptadeca-2,4,6,8,10,12,14,16-octaenal), or beta carotene (IUPAC ID: 1,3,3-trimethyl-2-[(1E,3E,5E,7E,9E,11E,13E,15E,17E)-3,7,12,16-tetramethyl-18-(2,6,6-trimethylcyclohexen-1-yl)octadeca-1, 3, 5, 7, 9, 11, 13, 15, 17-nonaenyl]cyclohexene).

In some embodiments of c) of the first aspect, the plant-based vegan simulated egg yolk composition comprises:
tomatoes in an amount of about 29.4 wt %, canola oil in an amount of about 24.8 wt %, Vividol-T oil in an amount of about 6.2 wt %, kala namak in an amount of about 1 wt %, calcium lactate in an amount of about 1 wt %, aquafaba in an amount of about 23.7 wt %, chickpeas in an amount of about 7 wt %, mustard in an amount of about 2 wt %, turmeric in an amount of about 0.5 wt %, miso paste in an amount of about 4.2 wt %, gum in an amount of about 0.1 wt % and natural orange colouring agent, such as apocarotenal, in an amount of about 0.2 wt %,
by weight of said egg yolk composition.

In a second aspect of the invention, there is provided, a method for producing a vegan simulated egg yolk composition of the first aspect, comprising the steps:
i) combine, until well-mixed, water and sodium alginate to form a 0.7% (7 g/L) alginate solution and refrigerate;
ii) combine, until well-mixed, the components defined in the first aspect, except calcium lactate, and remove fine particles with a fine mesh sieve;
iii) combine, until well-mixed, calcium lactate and the mixture of ii);
iv) refrigerate the mixture of iii) in portions in moulds for about 15 min;
v) place the moulds in a freezer for about 50-60 min;
vi) encase the portions of v) in the sodium alginate mixture i) by reverse-spherification to form simulated egg yolks.

The average weight of the plant-based egg yolk is about 11 g, with a diameter of about 3.8 cm, compared to an average chicken egg yolk of 13 g and a diameter of about 4 cm.

It would be understood that variations of the method could be made that would not substantially alter the product. For example, equivalents for the bowl, mesh sieve, moulds and slotted spoon may be used without departing from the essence of the method.

In a third aspect of the invention, there is provided a plant-based vegan simulated egg yolk composition produced by the method of the second aspect.

In a fourth aspect of the invention, there is provided a plant-based vegan simulated egg white composition having the sensory properties of an avian egg white, comprising the components:
tofu, flour, water, kala namak, a plant-based cream, a gum selected from the group of elastic gel-forming gums, preferably high acyl gellan gum; and
   a) fava bean protein; or
   b) tapioca starch and corn starch.

In some embodiments, the plant-based vegan simulated egg white composition, comprises:
a) tofu in an amount of about 60-80 wt %, rice flour in an amount of about 0.1-2 wt %, water in an amount of about 15-20 wt %, kala namak in an amount of about 0.1-2 wt %, plant-based cream in an amount of about 2-5 wt %, fava bean protein in an amount of about 2-10 wt % and gum in an amount of about 0.5-1.5 wt %; or
b) tofu in an amount of about 60-75 wt %, rice flour in an amount of about 5-10 wt %, water in an amount of about 15-20 wt %, kala namak in an amount of about 0.5-2 wt %, plant-based cream in an amount of about 5-10 wt %, tapioca starch in an amount of about 0.5-3 wt %, corn starch in an amount of about 0.5-3 wt % and gum in an amount of about 0.5-1.5 wt %, by weight of said egg white composition.

In some embodiments, the plant-based vegan simulated egg white composition further comprises a flavour masking agent. The masking agent preferably comprises maltodextrin, flavouring that enhances “creaminess” and “mouthfeel”, yeast extract and salt. A commercially available example of such a masking agent is marketed as a part of the “KOKUMI” type flavour by Ajinomoto. A flavour-masking agent may be required as the level of protein in the egg white is increased.

In some embodiments, the tofu is silken tofu; and/or the plant-based cream is selected from coconut, rice, oat, cashew and almond cream, preferably coconut.

In some embodiments, the plant-based vegan simulated egg white composition comprises:
a) fava bean protein in an amount of about 7%, tofu in an amount of about 71.9%, water in an amount of about 16%, coconut cream in an amount of about 3%, rice flour in an amount of about 0.5%, black salt in an amount of about 0.2% and gum in an amount of about 0.8%, by weight of said egg white composition; or
b) tofu in an amount of about 66.8 wt %, rice flour in an amount of about 7.2 wt %, water in an amount of about 15.6 wt %, kala namak in an amount of about 0.9 wt %, coconut cream in an amount of about 7.3 wt %, tapioca starch in an amount of about 0.53 wt %, corn starch in an amount of about 0.65 wt % and gum in an amount of about 0.74 wt %, by weight of said egg white composition.

Composition a) in the embodiment above contains overall 10 g of protein for 100 g of plant-based egg white, which is close to the protein content of a chicken egg white of about 10 wt % of protein by weight of said egg white.

In a fifth aspect of the invention, there is provided a method of producing a vegan simulated egg white composition of the fourth aspect, comprising the steps:
i) in a blender, combine the tofu, rice flour, water, kala namak, plant-based cream, gum, and
   a) fava bean protein, or
   b) tapioca starch and corn starch;
ii) blend the combination for about 30 sec, or until completely smooth;
iii) pulse the mixture for about 10 sec, wherein the blending is performed at about 22-24° C.

In some embodiments, the gum is high acyl gellan gum.

In a sixth aspect of the invention, there is provided a plant-based vegan simulated egg white composition produced by the method of the fifth aspect.

In a seventh aspect of the invention, there is provided a plant-based vegan simulated fried egg composition comprising a vegan simulated egg yolk composition having the sensory properties of an avian egg yolk and a vegan simulated egg white composition having the sensory properties of an avian egg white, wherein
a) the egg yolk composition comprises the components defined in the first or third aspect; and
b) the egg white composition comprises the components defined in the fourth or sixth aspect; wherein the egg yolk has been encapsulated by reverse-spherification.

In some embodiments, said yolk has been encapsulated using 7 g/L sodium alginate.

In an eighth aspect of the invention, there is provided a method of preparing the plant-based vegan simulated fried egg, comprising heating the plant-based vegan simulated egg white composition of the fourth or sixth aspect in a pan until it simulates a fried egg white; then associating the plant-based vegan simulated egg yolk of the first or third aspect with the fried egg white to resemble a fried egg.

In a ninth aspect of the invention, there is provided a kit or combination comprising:
i) a plant-based vegan simulated egg yolk composition of the first or third aspect and a plant-based vegan simulated egg white of the fourth or sixth aspect, wherein said egg white and said egg yolk are separated in a container by one or more barriers; or
ii) a plant-based vegan simulated egg yolk composition of the first or third aspect; or
iii) a plant-based vegan simulated egg white of the fourth or sixth aspect.

In some embodiments, in part (i) said egg white and said egg yolk are separated in the container by a single barrier.

In some embodiments, in part (ii) the egg yolk is packaged within a covering layer of vegetable oil to sustain the shape of the yolk.

### BRIEF DESCRIPTION OF THE FIGURES

FIG. 1A is a photograph of a vegan simulated egg yolk of the invention (top), made from a composition similar to the composition presented in Table 1, and a raw chicken yolk (bottom).

FIG. 1B is a photograph showing vegan simulated egg yolks made from different vegetable oils: (left to right) chicken egg from Egg Story Omega 3 and 6 and Vitamin E; (2) canola oil; (3) Akoplanet RSO 100-17; (4) Ako Veg 138-14; (5) AAK-SG-000037; (6) Ako Planet PBM 132-46; (7) Vividol® T.

FIG. 1C is a photograph showing a chicken egg yolk, a vegan simulated egg yolk made from Akoplanet RSO 100-17 and a vegan simulated yolk from a blend of 20% Vividol® T and 80% Akoplanet RSO 100-17.

FIG. 2 shows a graph of the comparative average firmness (g) of plant-based simulated yolks made according to the composition in Table 1 with different vegetable oils shown in Table 3. Left to right; (1) canola oil; (2) Akoplanet RSO 100-17; (3) Ako Veg 138-14; (4) AAK-SG-000037; (5) Ako Planet PBM 132-46; (6) Vividol® T; compared to the average firmness of a raw chicken egg yolk (7) chicken egg from Egg Story Omega 3 and 6 and Vitamin E.

FIG. 3 shows comparative photos of several plant-based egg yolks made from different vegetable oils versus raw chicken egg yolk after texture analysis. Egg 2, yolk flowed out rapidly and spread after being punctured; Egg 3, yolk flowed out rapidly and spread out after being punctured; Egg 4, yolk able to hold its shape after test and was slightly compressed but not punctured (target distance at 4 mm); Egg 5, yolk oozed out from several points but did not spread; Egg 6, yolk oozed out from several points and slightly spread (some oil separation); Egg 7, yolk flowed out slowly and spread slightly after being punctured; Chicken Egg, yolk able to absorb the force and did not puncture at 4 mm, 6 mm and 9 mm; Chicken Egg, yolk not fresh and punctured at 6 mm force.

FIG. 4 shows photographs comparing several plant-based egg yolks versus chicken egg yolk, cooked as sunny side up. The vegan egg yolks Egg 2, Egg 3 and Egg 7 correspond to those listed in Table 5. The vegan egg white composition used for this test is described in Table 9. Egg 2 consistency was watery with liquid-like mouthfeel and salty taste; Egg 3, consistency was runny and creamier mouthfeel than Egg 2 and most rounded in taste compared to the rest; and Egg 7, consistency was thicker and more like a chicken egg but with muted taste.

FIG. 5 is a graph showing that the average viscosity of chicken egg yolk varied from 326.63 mPa·s (lane 11) to 527.5 mPa·s (lane 12) while the average viscosities of vegan egg yolk samples 2 to 11 ranged from 307.63 mPa·s to 473.42 mPa·s. Vegan egg yolk formulations based on the composition of Table 1 with the oil substituted as per Table 5 (Egg 2 to Egg 11) are shown in lanes 1 to 10. Left to right; (1) canola oil; (2) Akoplanet RSO 100-17; (3) Ako Veg 138-14; (4) AAK-SG-000037; (5) Ako Planet PBM 132-46; (6) Vividol® T; (7) Akoplanet RSO 100-17; (8) AkoPlanet™ RSO 100-17+soy lecithin; (9) AkoPlanet™ RSO 100-17+high shear; (10) 20% Vividol® T: 80% AkoPlanet™ RSO 100-17. It was deduced that there were no significant differences between the viscosity of vegan egg yolks of the invention and chicken egg yolks.

FIG. 6 shows a photograph of vegan simulated egg yolks of the invention served uncooked on a shakshuka, a classic North African and Middle Eastern dish.

FIG. 7 shows photographs of a vegan pasta dough making process using vegan simulated egg yolks of the invention.

FIG. 8 shows a photograph of a crème brûlée made using vegan simulated egg yolks having the composition shown in Table 8, through the incorporation of the vegan simulated egg yolks as a substitution for chicken egg yolks in the recipe.

FIG. 9 shows a photograph of a brioche made using vegan simulated egg yolks as a substitution for chicken egg yolks.

FIG. 10 shows a photograph of a hollandaise sauce made from vegan simulated egg yolks.

FIGS. 11 and 12 show photographs of chocolate chip cookies prepared with vegan simulated egg yolks of the invention.

FIGS. 13A-13C show photographs of a custard tart prepared with vegan simulated egg yolks of the invention.

FIG. 14A-B show images of omelettes prepared from the vegan simulated egg white composition of the invention.

FIG. 15 shows a photograph of a vegan egg drop soup prepared with the vegan simulated egg white composition of the invention.

FIG. 16 shows photographs of plant-based simulated fried eggs of the invention.

### DETAILED DESCRIPTION OF THE INVENTION

### Definitions

Certain terms employed in the specification, examples and appended claims are collected here for convenience.

It must be noted that as used herein and in the appended claims, the singular forms “a”, “an”, and “the” include plural reference unless the context clearly dictates otherwise. As used herein, the term “comprising” or “including” is to be interpreted as specifying the presence of the stated features, integers, steps or components as referred to, but does not preclude the presence or addition of one or more features, integers, steps or components, or groups thereof. However, in context with the present disclosure, the term “comprising” or “including” also includes “consisting of”. The variations of the word “comprising”, such as “comprise” and “comprises”, and “including”, such as “include” and “includes”, have correspondingly varied meanings.

Having now generally described the invention, the same will be more readily understood through reference to the following examples which are provided by way of illustration, and are not intended to be limiting of the present invention.

In this invention, an oil blend may comprise oils from 2 or more plant sources. For example, the oil blend may comprise rapeseed oil, canola oil, peanut oil, vegetable oil, soya bean oil or a combination thereof. The oil blend may be a commercially available oil, such as Vividol® T.

### Example 1: Vegan Egg Yolk

Natural egg yolks contain a high percentage of fat as well as protein and water. The fat content can add richness to baked goods, and the yolk's ability to emulsify is important in combining liquid and fats into a cohesive mixture, such as when baking a mayonnaise sauce or creating a homogenous batter or dough. They also thicken mixtures and add flavour and colour to baked goods. Ideally, a plant-based vegan egg yolk can replicate the attributes of a natural egg yolk.

The plant-based vegan egg yolk of embodiments of the invention comprises the following components: calcium lactate, chickpeas, tomatoes or beta carotene, turmeric, canola oil, and a fermentation agent. Further ingredients were required to achieve a fully functional egg yolk substitute that mimics the properties of a chicken egg. These ingredients include aquafaba, black salt, mustard. Ingredients such as paprika, a gum, and chilli powder may be included depending on whether other ingredients are added to the composition.

### 1.1 Components of Two Simulated Yolks

Tomatoes are a source of beta carotene. They also provide a warm tone to the yellow colour and add a slight acidity to the composition. The tomatoes can be in a paste, puree or diced form.

Canola oil is a vegetable oil derived from a variety of rapeseed, having close to a neutral taste and a texture ideal to recreate the mouthfeel of a chicken yolk, without any off-tastes. Canola oil also has low levels of saturated fatty acids and high levels of unsaturated fats, which position it as a health-promoting component of the diet. [Lin et al. (2013) Nutrition Reviews 71(6):370-385]. The amount of canola oil used in an embodiment of the invention is from about 30 wt % of the yolk composition. The canola oil may be used in the invention alone or in a blend with other oils. For example, canola oil may be blended with Vividol® T oil.

Vividol® T oil (a fat blend based on pine phyto-sterols and rapeseed oil) was obtained from plant-based oil and fat company, AAK SG Pte Ltd., Singapore 13856. This oil provides an interaction with the other ingredients to meet various sensory parameters and match that of chicken eggs. These parameters include viscosity, taste and colour. Phytosterols can be esterified to sterol esters to modify them into liquid or semi-liquid to more easily incorporate into the egg composition. Plant sterol esters have been shown to reduce the level of low-density lipoprotein (LDL) cholesterol in blood when ingested. Reduction of plasma LDL cholesterol originating from the diet is highly desirable to help decrease the prevalence of atherosclerosis and mortality from CVD.

The total percentage of oil component in the yolk formulation is 30 wt %. An oil blend of Vividol® T and canola oil can be used in the formation of the plant-based vegan simulated egg yolk, in the range of 3 wt % to 30 wt % of Vividol® T in the formulation of the vegan egg yolk, preferably 6-20 wt %. When the Vividol® T is used in lower amounts, for instance at 3 wt %, the optimum level of viscosity is not achieved, and the plant-based vegan simulated egg yolks do not have the same level of runniness and stretch as compared to avian egg yolks. When the Vividol® T is used in higher amounts, for instance at 27 wt %, the optimum level of colour is not achieved.

Other phytosterol-containing oil blends that include pine and rapeseed oil may be suitable as an alternative to Vividol® T oil.

Calcium lactate is a fat-soluble agent that reacts with sodium alginate to form a skin or membrane around a food item that is submerged in the sodium alginate solution. Other sources of calcium were used in place of calcium lactate for spherification of our vegan egg yolk, but they demonstrated inferior performance. Calcium chloride gave an unpleasant bitter taste. Calcium gluconate performed poorly in terms of gelation kinetics (20 times and 4 times slower than calcium chloride and calcium lactate, respectively). Calcium lactate had a rate of gelation that was similar to calcium chloride without adversely affecting the organoleptic properties of the vegan egg yolk. The concentration of calcium lactate used in the invention for spherification is preferably from about 0.5 to 2 wt %, more preferably about 0.9 to 1 wt % of the yolk composition.

Chickpeas (Cicer arietinum) contain high levels of complex carbohydrates and unsaturated fatty acids, vitamins, and minerals. Two main varieties of chickpeas are the larger round light-coloured Kabuli-type, common in the United States, and the smaller dark irregularly shaped Desi-type often used in India and the Middle East. Other legumes may be alternatives to chickpeas. The concentration of chickpeas used in an embodiment of the invention is from about 5 to 20 wt %, preferably about 9 to 10 wt % of the yolk composition. Chickpeas (Cicer arietinum) contain high levels of complex carbohydrates and unsaturated fatty acids, vitamins, and minerals. Two main varieties of chickpeas are the larger round light-coloured Kabuli-type, common in the United States, and the smaller dark irregularly shaped Desi-type often used in India and the Middle East. Other legumes may be alternatives to chickpeas. The concentration of chickpeas used in an embodiment of the invention is from about 5 to 20 wt %, preferably about 9 to 10 wt % of the yolk composition.

Turmeric is a product of Curcuma longa, a rhizomatous herbaceous perennial plant belonging to the ginger family Zingiberaceae, which is native to tropical South Asia. When the turmeric rhizome is dried, it can be ground to a yellow powder with a bitter, slightly acrid, yet sweet, taste. It is used in this formulation as a colouring agent.

Miso is used in the composition of the plant-based yolk as a fermentation agent and source of vitamins and minerals. It is a natural source of probiotics, vitamin B1, vitamin B2, vitamin B3, vitamin B5 and vitamin B9, as well as vitamins K and E. Miso also confers a yellow hue to the egg yolk and includes a slight umami taste which helps to recreate the umami compound of a chicken egg yolk. The concentration of miso (in paste form) used in an embodiment of the invention is from about 3 to 4 wt % of the yolk composition.

Black Salt, also known as kala namak, or Himalayan black salt, consists primarily of sodium chloride and traces of sodium bisulfite and hydrogen sulfide which provides black salt its distinctive taste and smell. The concentration of black salt used in an embodiment of the invention is from about 0.1 to 0.6 wt %, preferably 0.2 to 0.3 wt % of the yolk composition.

Aquafaba is the liquid leftover from cooking legumes and is often found in the form of a milky, mucilaginous liquid harvested from cans of chickpeas and its main components include polysaccharides, sucrose, and various proteins. Aquafaba also contains saponins, which are characterized by the soap-like foam they produce when shaken. When used in the invention, aquafaba allows the vegan egg composition to emulsify, coagulate and foam and to resemble the look and texture of a normal chicken egg. The concentration of aquafaba used in an embodiment of the invention is from about 0.1-0.6 wt %, preferably 0.2-0.3 wt % of the yolk composition. Alternatively, an emulsifier and/or a foaming agent may be used.

Mustard is selected from the group comprising Dijon mustard, English mustard and whole grain mustard, preferably Dijon mustard. Mustard contains isothiocyanates to contribute “sulfury” character. Mustard is also a source of calcium, iron, selenium, and phosphorus.

Paprika is a powdered, generally orange-red to deep blood-red spice made typically from grinding the dried pods of sweet red bell peppers (Capsicum annuum). It offers a unique culinary experience and when prepared by naturally drying the fruits, rather than the high heat of commercial preparations, it also offers a very rich source of vitamin C. It is used in this formulation as a colouring agent.

Xanthan gum is an exopolysaccharide secreted by the microorganism Xanthomonas campestris. Advantageously, this hydrocolloid exhibits excellent stabilizing effect to prevent separation of immiscible liquids and possesses a much weaker gelation ability so as to maintain a consistency similar to that of a real egg yolk.

In some embodiments of the invention, the relative amounts of egg yolk composition components are as shown in Table 1.

TABLE 1
Components of egg yolk composition

| | | |
|---|---|---|
| 7 | g | organic mild sodium miso |
| 55 | g | aquafaba |
| 20 | g | chickpeas (from a can) |
| 60 | g | canola oil |
| 3 | g | Dijon mustard |
| 60 | g | Diced tomatoes (Delmonte) |
| 0.5 | g | turmeric |
| 1 | g | paprika |
| 0.25 | g | chilli powder |
| 0.5 | g | kala namak (black salt) |
| 2 | g | calcium lactate powder |

Sodium alginate is a thickening and gelling agent that forms heat stable gels in the presence of calcium. This property allows for the production of gelled spheres, using frozen reverse spherification. Gels formed from alginates also have the ability to withstand heating to as high as 150° C. without melting, making it a versatile product to be used in replicating the membrane of a chicken egg yolk. The concentration of sodium alginate used in the invention for spherification is from about 0.5 to 1 wt %, preferably about 0.7 wt %.

In some embodiments, the egg yolk composition further comprises a phytosterol-containing oil blend that includes pine and rapeseed oil. Preferably, the phytosterol-containing oil blend that includes pine and rapeseed oil is used to substitute for a proportion of the canola oil. Preferably, Vividol® T oil (AAK SG Pte Ltd., Singapore) is used.

In some embodiments of the invention, the egg yolk composition components are as shown in Table 2.

TABLE 2
Components of egg yolk composition

| Composition (wt %) | |
|---|---|
| 2-5 | miso |
| 20-30 | aquafaba |
| 5-10 | chickpeas |
| 10-25:20-5 | canola oil:Vividol ® oil |
| 1-5 | Dijon mustard |
| 25-35 | Diced tomatoes |
| 0.1-2 | turmeric |
| 0.5-2 | kala namak (black salt) |
| 0.05-2 | gum |
| 0.5-2 | calcium lactate |
| 0.1-2 | Natural orange colouring agent (apocarotenal) |

Preferably the gum is selected from xanthan gum.

### 1.2 Method of Preparation

i) combine, until well-mixed, water and sodium alginate to form a 0.7% (7 g/L) alginate solution and refrigerate;
ii) combine, until well-mixed, the components defined in Table 2, except calcium lactate, and remove fine particles with a fine mesh sieve;
iii) combine, until well-mixed, calcium lactate and the mixture of ii);
iv) refrigerate the mixture of iii) in portions in moulds for about 15 min;
v) place the moulds in a freezer for about 50-60 min;
vi) encase the portions of v) in the sodium alginate mixture i) by reverse spherification to form simulated egg yolks.

The average weight of the plant-based egg yolk is about 11 g, with a diameter of about 3.8 cm, compared to an average chicken egg yolk of 13 g and a diameter of about 4 cm.

It would be understood that variations of the method could be made that would not substantially alter the product. For example, equivalents for the bowl, mesh sieve, moulds and slotted spoon may be used without departing from the essence of the method.

### 1.3 Optimization of Yolk Encapsulation with Alginate

For chicken egg yolks, the vitelline membrane is the extracellular protein membrane covering the yolk. The mechanical properties of the vitelline membrane, including its strength, can be considered a measurement of egg freshness.

In order to assess the effect of spherification on vegan egg yolk characteristics, several concentrations of sodium alginate and calcium lactate use in spherification were tested. Characteristics of thickness, strength, breakability and viscosity of the vegan egg yolk membrane were compared to a chicken egg yolk membrane. The vegan egg yolk tested was prepared using the components as detailed in Table 1.

Based on the thickness, breakability, and stress tests, several concentrations of calcium lactate (ranging from 1 g to 3 g for 175 g of egg yolk mixture) and sodium alginate (ranging from 0.5% to 1% for 1 L of water) allow the obtention of a membrane. However, the optimal result in terms of strength of the membrane, taste and mouthfeel, is obtained with a concentration of 0.7 wt % of sodium alginate for spherification and 2 g (about 1 wt %) of calcium lactate per 175 g of yolk mixture.

### Example 2: Texture

### 2.1 Effect of Oil Component on Vegan Yolk Firmness Compared to Chicken Egg Yolk

Vegan egg yolks were made with the components listed in Table 1, whereby the oil component was substituted by various oils. The oil components in the yolks are listed in Table 3 below:

TABLE 3
Oil component of egg yolks

| Sample | Description |
|---|---|
| Egg 2 | Oil component: 100% Naturel Brand canola oil |
| Egg 3 | Oil component: 100% AAK AkoPlanet ™ RSO 100-17 |
| | refined and pressed canola oil |
| Egg 4 | Oil component: 100% AAK AkoVeg ™ 138-14 non- |
| | hydrogenated refined blend of specialty vegetable oil/fat |
| | containing lauric oils |
| Egg 5 | Oil component: 100% AAK-SG-000037 non-hydrogenated |
| | refined blend of specialty vegetable oil/fat containing lauric |
| | oils |
| Egg 6 | Oil component: 100% AAK AkoPlanet ™ PBM 132-46 |
| | highly stable semi-liquid oil based on shea oil |
| Egg 7 | Oil component: 100% AAK Vividol ® T novel specialty |
| | fat blend containing pine sterols and rapeseed oil |
| Egg 11 | Oil component: 20% AAK Vividol ® T novel specialty fat |
| | blend containing pine sterols and rapeseed oil; 80% AAK |
| | AkoPlanet ™ RSO 100-17 refined and pressed canola oil |
| Chicken Egg | Chicken egg rich in Omega 3&6 and Vitamin E. |
| (Egg story) | |
| Chicken Egg | Normal commercial chicken egg. |
| (Cheers) | |

Each test was conducted using a Stable Micro Systems Texture Analyser with the following settings:

Probe: P/25 (25 mm Dia Cylinder)
Test Mode: Compression
Test Speed: 1.50 mm/s
Target Distance: 4 mm

Table 4 and FIG. 2 provide comparative average firmness (g) of plant-based yolks made from different vegetable oils versus the average firmness of a raw chicken egg yolk.

TABLE 4
Comparative firmness (g) of plant-based yolks made from
different vegetable oils and raw chicken egg yolks

| | | | Firmness |
|---|---|---|---|
| | Firmness | Firmness | Average |
| | Reading 1 | Reading 2 | Readings |
| Sample | (g) | (g) | (g) |
| Egg 2 (Naturel Brand Canola Oil) | 35.59 | 65.46 | 50.525 |
| Egg 3 (Akoplanet RSO 100-17) | 44.92 | 35.25 | 40.085 |
| Egg 4 (AkoVeg 138-14) | 270.68 | 240.6 | 255.64 |
| Egg 5 (AAK-SG-000037) | 82.32 | 93.08 | 87.7 |
| Egg 6 (Akoplanet PBM 132-46) | 77.42 | 95.92 | 86.67 |
| Egg 7 (Vividol T) | 71.66 | 77.62 | 74.64 |
| Egg 11 (20% Vividol T; 80% | 63.80 | 42.64 | 53.22 |
| Akoplanet RSO 100-17) | | | |
| Chicken Egg (Egg Story)* | 46.86 | — | 46.86 |

*Target distance: 9 mm
*Duplicate testing

The results provided in Table 4 and FIG. 2 demonstrate that the vegan yolks made with canola oils (sample 2 and sample 3) had the closest firmness to a commercially available chicken egg yolk (with a range going from an average 40.085 g to 50.525 g for the vegan yolk versus that of a chicken yolk with an average 46.86 g). Alternatively, the composition made with Vividol® T (sterol esters and rapeseed oil) as the only source of oil was the next closest to chicken yolks in terms of firmness. The results of the sensory evaluation of the vegan eggs showed that the vegan egg yolk made of Vividol® T resembled the gooey texture of a chicken egg yolk. Therefore, it is preferable to use the combination of canola oil and Vividol® T oil (sample 11).

### 2.2 Effect of Oil Component on Vegan Yolk Viscosity Compared to Chicken Egg Yolk

Vegan egg yolks were made with the components listed in Table 1, whereby the oil component was substituted by various oils. The oil component of each composition tested for viscosity was 30 wt % of total yolk composition and is listed in Table 5.

TABLE 5
The oil components in the tested yolks.

| Sample | Description | |
|---|---|---|
| Egg 2 | Oil component: 100% Naturel Brand canola oil | |
| Egg 3 | Oil component: 100% AAK AkoPlanet ™ RSO 100-17 refined and | |
| | pressed canola oil | |
| Egg 4 | Oil component: 100% AAK AkoVeg ™ 138-14 non-hydrogenated refined | |
| | blend of speciality vegetable oil/fat containing lauric oils | |
| Egg 5 | Oil component: 100% AAK-SG-000037 non-hydrogenated refined | |
| | blend of speciality vegetable oil/fat containing lauric oils | |
| Egg 6 | Oil component: 100% AAK AkoPlanet ™ PBM 132-46 highly stable semi- | |
| | liquid oil based on shea oil | |
| Egg 7 | Oil component: 100% AAK Vividol ® T novel speciality fat blend | |
| | containing pine sterols and rapeseed oil | |
| Egg 8 | Same formulation as Egg 3 | |
| Egg 9 | 1. | Oil component: 100% AAK AkoPlanet ™ RSO 100-17 refined and |
| | | pressed canola oil |
| | 2. | Soy lecithin was added as an emulsifier in the formulation (0.5-1%). |
| Egg 10 | 1. | Oil component: 100% AAK AkoPlanet ™ RSO 100-17 refined and |
| | | pressed canola oil |
| | 2. | The mixture was further mixed with a Silverson high shear |
| | | mixer. |
| Egg 11 | Oil component: 20% AAK Vividol ® T novel speciality fat blend | |
| | containing pine sterols and rapeseed oil; 80% AAK AkoPlanet ™ RSO | |
| | 100-17 refined and pressed canola oil | |
| Chicken Egg | Chicken egg rich in Omega 3&6 and Vitamin E. | |
| (Egg story) | | |
| Chicken Egg | Normal commercial chicken egg | |
| (Fairprice Brand) | | |

Each test was conducted based on the following settings:
Equipment: Brookfield DV3T Viscometer
Shear Rate: 50 1/s
Temperature: 25° C.
Data Interval: 30 s
Test duration: 10 min
Unit: mPa·s (millipascal-second)

FIG. 5 shows that the average viscosity of chicken egg yolk varied from 326.63 mPa·s to 527.5 mPa·s while the average viscosities of samples (Eggs) 2 to 11 ranged from 307.63 mPa·s to 473.42 mPa·s (FIG. 5, lanes 1-10). It was deduced that there were no significant differences between the viscosity of vegan egg yolks and chicken egg yolks. Sample 11 was chosen as the optimal formulation based on the firmness test shown in Table 4.

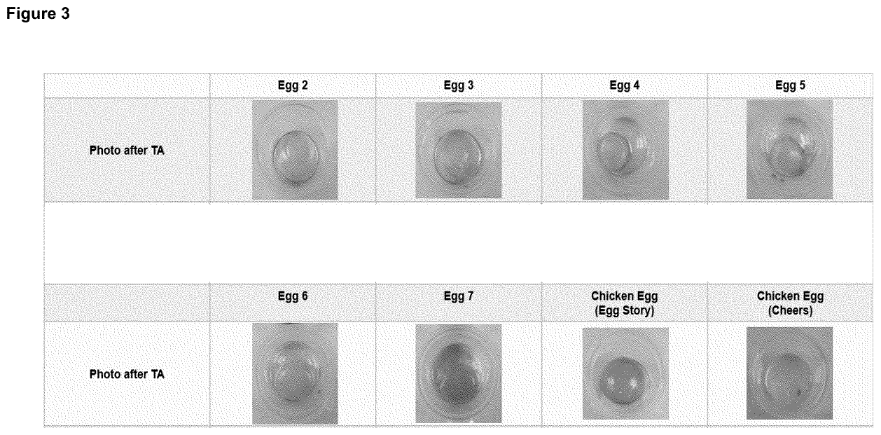

FIG. 3 provides comparative photos of several plant-based egg yolks made from different vegetable oils versus raw chicken egg yolk after texture analysis. As shown in FIG. 3 the vegan egg yolk compositions made using canola oils (samples 2 and 3) as the only source of oil were the compositions that most resembled the chicken yolks in texture tests. Alternatively, the composition made using Vividol® T oil (sample 7) as the only source of oil was the next closest to chicken yolks.

The trials conducted on the various vegan yolk compositions demonstrate that the oil component is a key ingredient to enable the replication of the firmness and viscosity of a chicken yolk. Based on the results, it is preferable to use in the vegan yolk composition a blend of oil containing one type of canola oil and Vividol® T.

Further research demonstrated that 10 wt % to 30 wt % of Vividol® T incorporated into the formulations of the vegan egg yolk provided similar colour and mouthfeel to that of raw chicken egg yolk. It was observed that the orange colour intensity and the thickness of the yolk mixture increased with the concentration of the Vividol® T. Based on the results of sensory evaluation, it was concluded that 6 wt % to 20 wt % of Vividol® T in the formulations provide the optimal mouthfeel and yellow-orange colour to the yolks.

### 2.3 Effect of Oil Component on Vegan Yolk pH Compared to Chicken Egg Yolk

Vegan egg yolks were made with the components listed in Table 1, whereby the oil component was two different canola oils (sample 2 and sample 3).

The oil component of each composition tested for viscosity was about 30 wt % of total yolk composition.

The vegan egg composition comprises naturally occurring acid ingredients such as tomatoes, mustard and miso. The pH readings conducted on the vegan yolk samples demonstrated, as seen in Table 6, that the vegan yolk composition is acidic with a pH less than 5. This natural acidity helps to prevent the vegan yolk composition from spoilage, and trials have demonstrated that the vegan yolk composition has a shelf life of 14 days without the addition of preservatives, which is commercially beneficial.

TABLE 6
pH readings.
pH Readings:

| Sample | Readings |
|---|---|
| Egg 2 (Canola Oil) | 4.86 |
| Egg 3 (Akoplanet RSO 100-17) | 4.91 |
| Chicken Egg (Egg Story) | 6.32 |

Dressings, sauces, marinades and similar liquid food products such as the vegan yolk composition, before encapsulation, depend on their acidity to prevent spoilage. The acidity of the food products helps to inhibit microbial growth.

### Example 3: Vegan Egg Yolk Colour

Chicken egg yolks naturally offer a wide range of colours, from pale yellow to bright yellow to neon orange. The yolks can sometimes be used to provide a certain colour to the food (e.g. glazing), in cooking or baking preparation.

The colour profile of the vegan egg yolk composition was modified by blending natural and/or artificial colourings (such as turmeric, mustard, apocarotenal, or beta carotene) in different amounts (from 0.2 wt % to 3 wt %) and by using different plant-based oil/fat. Depending on the dosage of the colouring and oil composition, the vegan egg yolk colour can be customised and can range from bright yellow to dark orange, enabling the imitation of the natural chicken yolk colour spectrum. In some embodiments an artificial yellow colouring may be used in an amount from about 0.1 wt % to 2 wt % of total yolk composition.

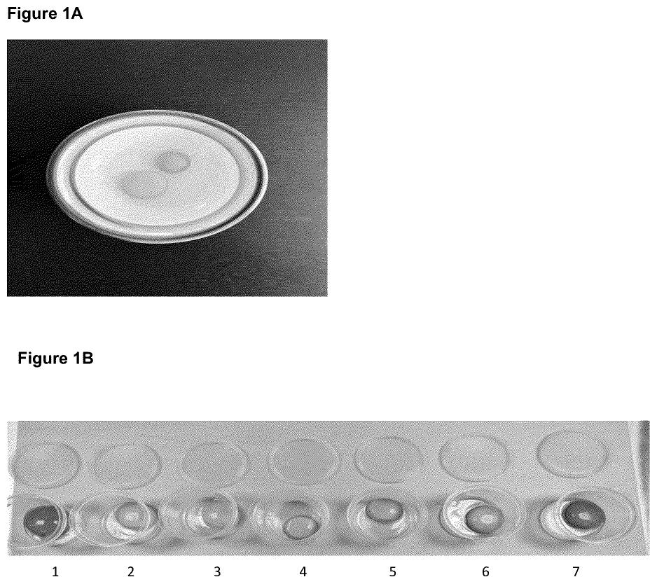

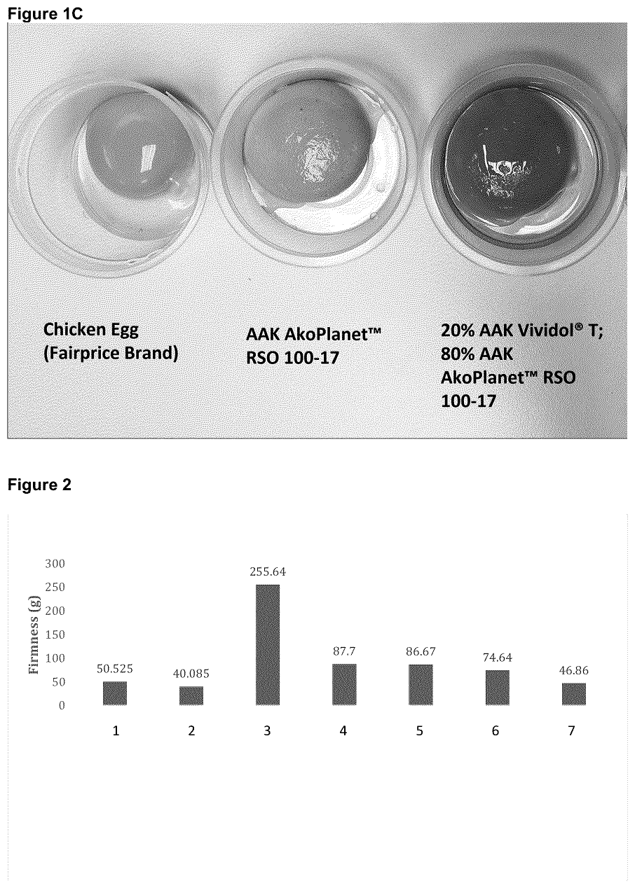

FIG. 1A is a photograph of the vegan egg yolk (top), made from a composition similar to the composition presented in Table 1, and a raw chicken yolk (bottom). The photo shows that the vegan egg yolks' colour can present a similar orange colour to that of a chicken yolk. As seen in FIG. 1B, the vegan egg yolk colour is influenced based on the type of vegetable or seed oil used in the composition (in each sample the oil compound was 30 wt % of total yolk composition).

FIG. 1B is a photograph showing vegan egg yolks made from different vegetable oils: (left to right) chicken egg from Egg Story Omega 3 and 6 and Vitamin E; (2) canola oil; (3) Akoplanet RSO 100-17; (4) Ako Veg 138-14; (5) AAK-SG OD0037; (6) Ako Planet PBM 132-46; (7) Vividol® 7. These yolks and oils are described in Example 2.2 Table 5.

FIG. 1C is a photograph showing a chicken egg yolk, a vegan egg yolk made from Akoplanet RSO 100-17 and a vegan yolk from a blend of 20% Vividol® T and 80% Akoplanet RSO 100-17.

### Example 4: Vegan Egg Yolk Comprising β-Glucan

A further improved egg yolk of the invention is provided by adjusting the components of Example 1 and adding a component that has positive health benefits of lowering blood cholesterol. The egg yolk contains a source of beta-glucans while retaining as many of the original components as possible.

### 4.1 Components

Oat bran can be used as a source of beta glucan. It is a by-product of oat (Avena sativa L.) grain processing and is a good source of b-glucans that have been linked to the reduction of cholesterol and to the prevention of cardiovascular diseases. Additionally, recent studies insinuate that oat beta glucans can support gastrointestinal health and assist in weight management by promoting satiety and/or reducing energy intake at meals.

An example of a high beta-glucan oat bran is marketed as SWEOAT™ BRAN BG28 XF (Swedish Oat Fiber AB, Sweden). To produce high beta-glucan oat bran, clean oat groats or rolled oats are ground and the resulting oat flour is separated by sieving, bolting and/or other suitable means into fractions so that the oat bran fraction is not more than 50% of the starting material, and has total β-glucan content of at least 5.5%. Detailed methods for producing dietary oat bran fibre containing β-glucan can be found, for example, in PCT/SE2009/051355 (WO 2011/065880 A1), the contents of which are hereby incorporated by reference.

Alternatives include oat fiber powder or beta glucans from other grain brans, in particular barley beta glucan. Oat bran powder is preferred because it carries 23% protein and the beta glucans in oat provide scientifically proven health results. In some embodiments, the vegan yolk composition comprises oat bran powder in a range of about 1-5 wt %.

Lecithin is a food additive used as an emulsifier when added to food and, advantageously, also has uses as an antioxidant and flavor protector. Alternatives include lecithin from sunflower and rapeseed, but soy lecithin is preferred as it offers similar health benefits to other types of lecithin and is more easily accessible. In some embodiments, the vegan yolk composition comprises lecithin in a range of about 0.5-1 wt %.

Natural, plant-based food flavourings are used to impart sulphury note and full-bodied, creamy mouthfeel sensation to vegan simulated egg yolk. Alternatives include black salt and sugar than can provide the smell of sulphur and mouthfeel, respectively, but the increasing metabolic diseases related to high consumption of added sugar and salt as well as their effect on the overall flavor profile is a big concern.

Calcium lactate is a fat-soluble agent that reacts with sodium alginate to form a skin or membrane around a food item that is submerged in the sodium alginate solution.

Other sources of calcium were used in place of calcium lactate for spherification of our vegan egg yolk, but they demonstrated inferior performance. Calcium chloride gave an unpleasant bitter taste. Calcium gluconate performed poorly in terms of gelation kinetics (20 times and 4 times slower than calcium chloride and calcium lactate, respectively). Calcium lactate had a rate of gelation that was similar to calcium chloride without adversely affecting the organoleptic properties of the vegan egg yolk. The concentration of calcium lactate used in the invention for spherification is preferably about 1 to 3 wt % of the yolk composition.

Miso is used in the composition of the plant-based yolk as a fermentation agent and source of vitamins and minerals. It is a natural source of probiotics, vitamin B1, vitamin B2, vitamin B3, vitamin B5 and vitamin B9, as well as vitamins K and E. Miso also confers a yellow hue to the egg yolk and includes a slight umami taste which helps to recreate the umami compound of a chicken egg yolk. The concentration of miso (in paste form) used in an embodiment of the invention is from about 5 to 7 wt % of the yolk composition.

Chickpeas (Cicer arietinum) contain high levels of complex carbohydrates and unsaturated fatty acids, vitamins, and minerals. Two main varieties of chickpeas are the larger round light-coloured Kabuli-type, common in the United States, and the smaller dark irregularly shaped Desi-type often used in India and the Middle East. Other legumes may be alternatives to chickpeas. The concentration of chickpeas used in an embodiment of the invention is from about 10 to 15 wt %, preferably about 11 to 12 wt % of the yolk composition.

Canola oil is a vegetable oil derived from a variety of rapeseed, having close to a neutral taste and a texture ideal to recreate the mouthfeel of a chicken yolk, without any off-tastes. Canola oil also has low levels of saturated fatty acids and high levels of unsaturated fats, which position it as a health-promoting component of the diet. [Lin et al., (2013) Nutrition Reviews 71(6):370-385]. The amount of canola oil used in an embodiment of the invention is from about 15-20 wt % of the yolk composition.

Tomatoes are a source of beta carotene. They also provide a warm tone to the yellow colour and add a slight acidity to the composition. The tomatoes can be in a paste, puree or diced form.

Turmeric is a product of Curcuma longa, a rhizomatous herbaceous perennial plant belonging to the ginger family Zingiberaceae, which is native to tropical South Asia. When the turmeric rhizome is dried, it can be ground to a yellow powder with a bitter, slightly acrid, yet sweet, taste. It is used in this formulation as a colouring agent.

Gum. Preferably the type of gum used in the vegan yolk composition is gellan gum or xanthan gum. Gellan gum may be used for the purpose of providing the strength and stretch of the vegan egg patty of the invention to match that of a chicken egg. The native type (high acyl) gellan gum is used because it helps with the suspension of solid particles. The optimal amount of gellan gum used in the vegan yolk formulation ranges from 0.05 wt % to 0.1 wt %. Xanthan gum is considered to be very similar to (high acyl) gellan gum, in that they are both exopolysaccharides biosynthesized from the bacterial fermentation process and form a soft, elastic gel. However, high acyl gellan gum is preferred because it provides better texture and mouthfeel.

The composition of a preferred beta-glucan egg yolk is shown in Table 7.

TABLE 7
Components for beta glucan egg yolk composition

| Composition (wt %) | |
|---|---|
| 15-20 | Canola oil |
| 30-40 | Water |
| 10-15 | Chickpeas |
| 1-3 | Natural flavorings |
| 25-30 | Diced tomatoes |
| 0.1-0.5 | Turmeric |
| 5-7 | Miso |
| 1-5 | Oat bran powder |
| 1-3 | Calcium lactate |
| 1-1.5 | Natural yellow food coloring |
| 0.5-1 | Soy lecithin |
| 0.05-0.1 | Gellan gum |

Sodium alginate is a thickening and gelling agent that forms heat stable gels in the presence of calcium. This property allows for the production of gelled spheres, using frozen reverse spherification. Gels formed from alginates also have the ability to withstand heating to as high as 150 oC without melting, making it a versatile product to be used in replicating the membrane of a chicken egg yolk. The concentration of sodium alginate used in the invention for spherification is from about 0.5 to 1 wt %, preferably about 0.7 wt %.

### Example 5: Cooked Vegan Egg Yolk

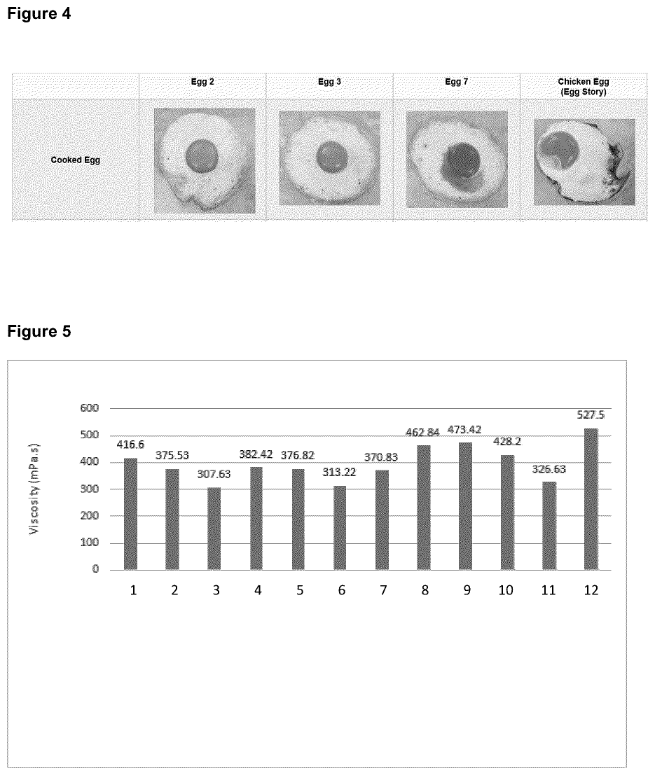

FIG. 4 provides a comparison of several plant-based egg yolks versus chicken egg yolk, cooked as sunny side up. The vegan egg yolks Egg 2, Egg 3 and Egg 7 correspond to those listed in Table 5. The vegan egg white composition used for this test is described in Table 8.

The samples shown in FIG. 4 have been cooked at a temperature range of 60° C. to 70° C. As seen, the vegan egg yolks compositions made using canola oil (Egg 2 and Egg 3) or using Vividol® (Egg 7) as the only source of oil are the compositions that most resemble the chicken yolk in the cooking test. While being exposed to the heat, these three vegan egg yolks compositions are able to hold their shape, and maintain a colour comparable to a chicken egg yolk.

However further testing indicated that the composition made using Vividol® T as the only source of oil appeared to be much darker (due to oxidation) and thicker after cooking which was not the most desirable mouthfeel and appearance for a yolk cooked as sunny side up as it should remain liquid and gooey. It was found that a blend of canola oil and Vividol® T in the egg yolk composition further improved the qualities of the cooked yolk compared with the use of canola or Vividol® T alone.

### Example 6: Applications of Vegan Egg Yolk

To demonstrate how similar the vegan egg yolk of the invention is to a natural chicken yolk, the vegan egg yolk was used as a chicken yolk substitute in several different food applications. The beta glucan egg yolk of Table 7 was used in all the same food preparations shown in the following Examples with no discernable functional difference.

### 6.1 Vegan Yolk Served on its Own

Raw or lightly cooked avian eggs can contain Salmonella bacteria which cause foodborne disease with serious symptoms such as diarrheal illness, typhoid fever and paratyphoid fever. Salmonellae are among the most common bacterial foodborne pathogens worldwide.

By being plant-based, the vegan yolk composition of the present invention practically eliminates the risk of development or transmission of Salmonella bacteria, which is beneficial from a public health and commercial standpoint.

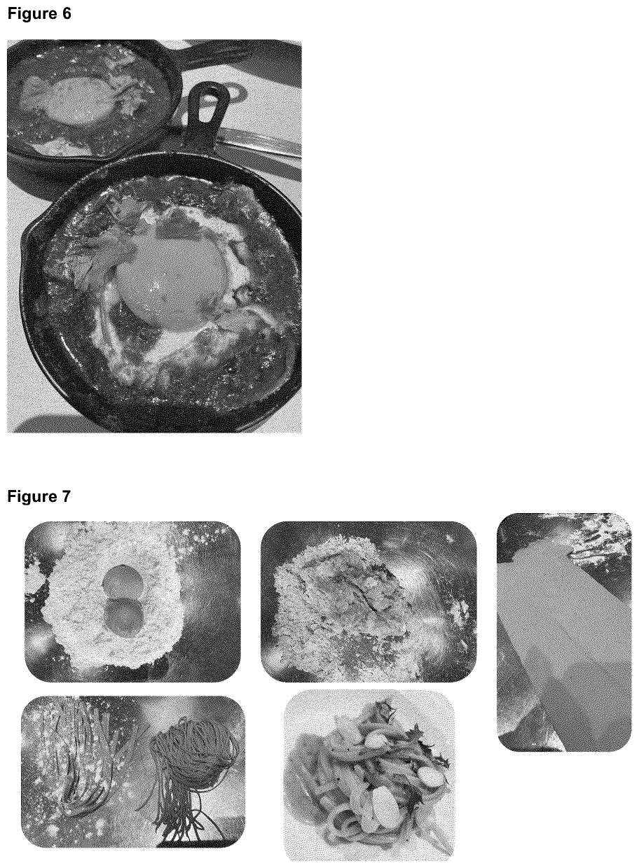

FIG. 6 depicts vegan egg yolks of the invention served uncooked on a shakshuka, a classic North African and Middle Eastern dish, with no risk of development or transmission of Salmonella bacteria. The traditional version of the shakshuka uses tomatoes, onions and spices as the base with raw chicken eggs on top.

### 6.2 Vegan Yolk as an Ingredient

Chicken egg yolks add a richness to both sweet and savory dishes, and can help thicken sauces and give baked goods more body. Chicken eggs can provide a desired viscosity as natural binding agents for the preparation of baked goods. The vegan egg yolk of the invention demonstrates egg-like functional qualities. The vegan egg yolk composition comprising beta glucan can equally be used as an ingredient in the following examples and substitute for the composition shown in Tables 2 and 8.

The applications i) to vii) described below have been prepared with yolks made from the composition in Table 2 with the proportions of ingredients shown in Table 8.

TABLE 8
Composition of vegan yolk used as an ingredient

| Composition (wt %) | |
|---|---|
| 4.2 | miso |
| 23.7 | aquafaba |
| 7 | chickpeas |
| 24.8:6.2 | canola oil:Vividol ® T oil |
| 2 | Dijon mustard |
| 29.4 | Diced tomatoes |
| 0.5 | turmeric |
| 1 | kala namak (black salt) |
| 0.1 | gum |
| 1 | calcium lactate |
| 0.2 | Natural orange colouring agent (apocarotenal) |

### i) Vegan Egg Pasta

A vegan pasta dough was prepared through the incorporation of the vegan simulated egg yolks as a two for one substitution for chicken egg yolks (FIG. 7). The result of this application is a smooth Italian pasta as seen in FIG. 7, that can then be used across various pasta preparations from carbonara to an arrabiata.

### Ingredients

### 150 g Flour

7 to 8 Vegan yolks made from the composition presented in Table 8

### Method

Place the flour in a bowl and add the vegan yolks.
Mix with hands the yolks and flour for 5 to 7 min, until the dough is smooth.
Usually let the dough rest for one hour.
After resting, place the dough in the pasta machine.
The thickness of the final dough should be around 2 mm to make great pasta.

### ii) Vegan Creme Brulee

A crème brûlée was made using vegan egg yolks having the composition shown in Table 8, through the incorporation of the vegan simulated egg yolks as a substitution for chicken egg yolks in the recipe (FIG. 8).

The usual cream/chicken yolks ratio in non-vegan creme brulee recipes is 2 to 3 cups (1 cup=236.5 mL) of cream for every 5 yolks used, depending on the desired richness. The cream/yolk ratio in the recipe used to make the vegan creme brulee is similar to the ratio in a non-vegan creme brulee. Hence, the vegan creme brulee has been prepared with a one-to-one or 100% substitution of chicken yolks for vegan egg yolks demonstrating the binding and sensory properties of Vegan egg yolks with the addition of a small quantity of starch.

### Ingredients

250 ml coconut milk
50 g caster sugar
25 g corn starch
2 Vegan plant-based egg yolk made from the composition presented in Table 8
2 tsp vanilla essence
Caramelized top ingredients: 1 tsp caster sugar per ramekin

### Method

Remove coconut milk from the chiller and add all ingredients in a blender and blend well.
Pour into a cold pan and heat up the mixture.
Stir well on medium heat until it thickens.
Spoon the mixture into ramekins and even out so that you get a flat surface. Let cool down and sit in the fridge for at least 1 hour.
Take out of the freezer and add 1 tsp of caster sugar on top of the crème, spread evenly Get a blow torch and caramelise the top.
iii) Vegan Brioche

Vegan simulated egg yolks were incorporated as a substitution for chicken egg yolks in a recipe for making brioche (FIG. 9).

The usual flour/chicken yolks ratio in non-vegan brioche recipes is 1 cup of flour (1 cup=236.5 mL) for each yolk used.
The flour/yolk ratio in the recipe used to make the vegan brioche is similar to the ratio in a non-vegan brioche. Hence, the vegan brioche sauce has been prepared with a one-for-one or 100% substitution of chicken yolks for Vegan egg yolks.

### Ingredients

416 g all-purpose flour
416 g bread flour
48 g sugar
6 g salt
9 g instant yeast
411 g unsweetened soy milk (room temperature or cold)
4 Vegan egg yolks made from the composition presented in Table 8
168 g vegan butter/margarine, softened
“egg wash”
1 Vegan egg yolk

### Method

### Make the Vegan Brioche Dough:

In the bowl of a stand mixer, using a dough hook combine flours, sugar, salt, and instant yeast.
Wisk the plant-based vegan egg yolks and unsweetened soy milk together until smooth.
Add this to the dry ingredients and mix together until the dough is just combined.
Using the stand mixer, knead the dough on low speed for 5 minutes to begin developing the dough, begin adding the vegan butter after 5 minutes of kneading.
Once the butter has been kneaded in, let the mixer continue to knead for another 15-20 minutes to develop the dough.
Turn the kneaded dough into a lightly oiled mixing bowl and turn the dough to coat in oil.
Cover the bowl and let rise at room temperature for 1 hour, at which point it will be puffy and increase about 50% in size.
Place the dough in the fridge and refrigerate for at least 4 hours but ideally overnight or up to 1 day.
Shape the dough into 15 balls of 100 g each. Cover the loaves with plastic wrap and let rise until about 1.5 times the original size. This will take about 1 hour depending on the ambient temperature.
Bake the loaves in a preheated oven at 180° C.
When the loaves have risen, brush them with the plant-based vegan egg yolk.
Bake for 30-35 minutes, or until the top is golden.
Remove the loaves immediately and let cool on a wire rack.

### iv) Vegan Hollandaise Sauce

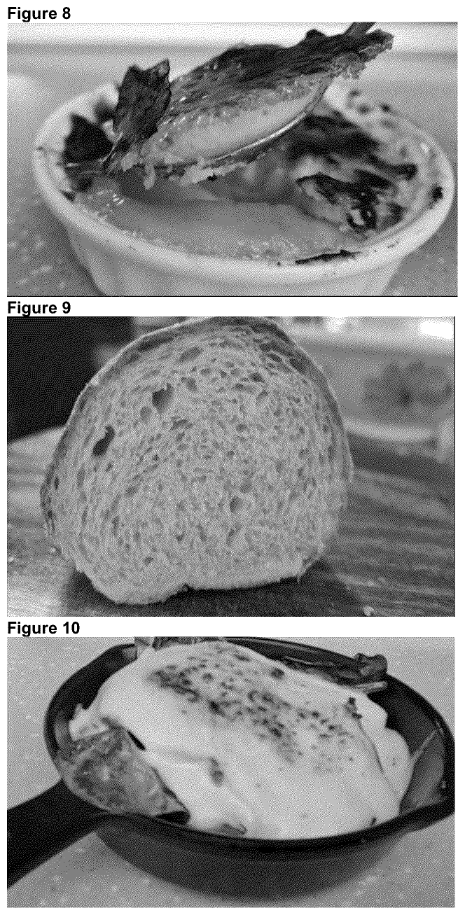

A hollandaise sauce was made from Vegan egg yolks, through the incorporation of the vegan simulated egg yolks as a substitution for chicken egg yolks in the recipe (FIG. 10).

The usual cream/chicken yolks ratio in non-vegan hollandaise sauce recipes is ½ a cup of butter (1 cup=236.5 mL) for every 3 yolks depending on the desired richness.
The butter/yolk ratio in the recipe used to make the vegan hollandaise sauce is similar to the ratio in a non-vegan hollandaise sauce. Hence, the vegan hollandaise sauce has been prepared with a one-for-one substitution of chicken yolks for Vegan egg yolks.

### Ingredients

112 g raw cashews
355 g water
20 g freshly squeezed lemon juice
54 g melted vegan butter or refined coconut oil
10 g nutritional yeast
1 tsp ground mustard seed
½ tsp white pepper
3 Vegan egg yolks made from the composition presented in Table 8
Pinch of ground cayenne

### Method

Combine all ingredients in a blender and blend until smooth. Transfer to a small pot and warm over low-medium heat until warm and thickened. Add water to thin if necessary. Enjoy immediately or save for later, reheating to serve. use as a condiment over grilled vegetables.

### v) Glaze

As described in 5.2 (iii) the vegan egg yolk of the invention may be used to glaze a brioche (FIG. 9) through a 1:1 substitution with a chicken yolk. The bright and gold glazing obtained with Vegan egg yolk is comparable to a glazing made with chicken yolk, demonstrating the glazing properties of the vegan yolk composition.

### Ingredients

1 Vegan egg yolk made from the composition presented in Table 8

### Method

When the brioche loaves have risen, brush them with the plant-based egg yolk.
Bake for 30-35 minutes, or until the top is golden.
Remove the loaves immediately and let cool on a wire rack.

### vi) Vegan Cookies

Vegan cookies were made from the vegan egg yolks, through the incorporation of the vegan simulated egg yolks as a substitution for chicken egg yolks in the recipe. The usual flour/whole chicken eggs ratio in non-vegan cookies recipe is about 150 g of flour for 1 egg and the usual sugar/whole chicken eggs ratio is 100 to 150 g of sugar for 1 egg.

The flour/egg yolk and sugar/egg yolk ratio in the recipe used to make the vegan cookies close to the ratio in non-vegan cookies. Hence, the vegan cookies have been prepared with a one-for-one substitution of chicken yolks for Vegan egg yolks.

The following ingredients and method enable the preparation of 14 to 16 cookies.

### Ingredients

250 g vegan butter
200 g light brown sugar
100 g caster sugar
½ tsp vanilla essence
3 Vegan yolks
325 g plain flour
1¼ tsp fine sea salt
¾ tsp bicarbonate of soda
250 g dark chocolate chips

### Method

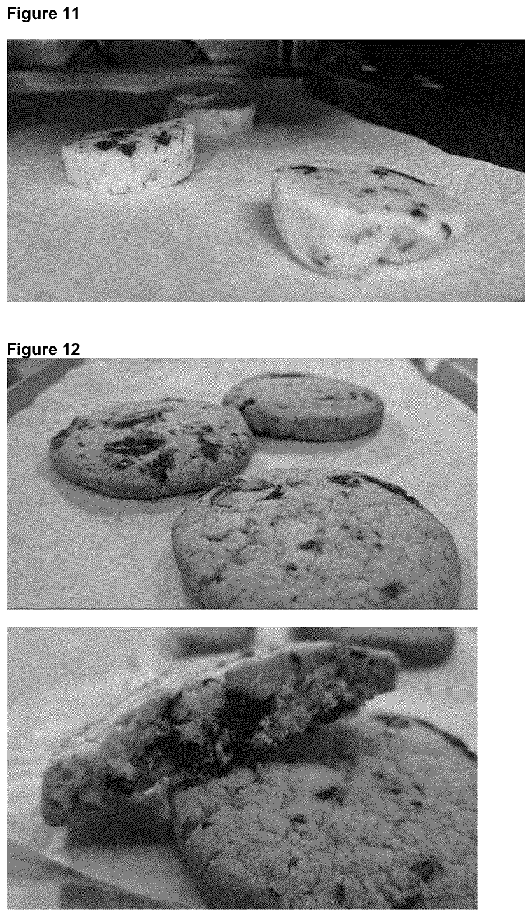

Line a baking tray or baking tin with parchment paper.
Beat the butter and sugars in the bowl of an electric mixer until combined but not too creamy—not aiming for light and fluffy here, as that would make the cookies too cakey. Add the vanilla essence and yolks and mix well.
In another bowl weigh out the flour, salt and bicarbonate of soda and whisk together well. Add this to the softened vegan butter and egg mixture along with the chocolate, and mix until combined.
Scoop individual portions of cookie dough onto the lined baking tray or tin. If using spoons, pat each portion into a little ball. Cover with cling film and freeze for at least 1 hour.
When ready to bake, preheat your oven to 160° C. Line a large baking tray or tin with parchment paper and arrange the cookies evenly on the tray, leaving enough space between each one so they have room to expand during baking. If you are baking from frozen, allow the cookies 5-10 minutes out of the freezer before placing in the oven.
Bake for 12 minutes, until the centre of each cookie is slightly soft and undercooked but the edges are crispy and golden. Remove from the oven and allow to cool on the tray for 10 minutes before serving. FIGS. 11 and 12 show chocolate chip cookies prepared with Vegan yolks of the invention.
vii) Vegan Custard Egg Tart

A vegan custard egg tart (filling and crust) was made from the vegan egg yolks, through the incorporation of the vegan simulated egg yolks as a substitution for chicken egg yolks in the recipe. The usual milk and water/chicken eggs ratio in a non-vegan custard tart recipe is about 1 cup of liquid for 4 eggs. The liquid/egg yolk ratio in the recipe used to make the vegan filling of the tart close to the ratio in non-vegan tart. Hence, the vegan egg yolks provide similar taste and color to chicken yolks. A small quantity of starch and agar agar have been added to strengthen the binding effect.

### Ingredients for the Crust

Butter dough
125 g all-purpose flour
113 g cold vegan butter
pinch of salt

### Water Dough

125 g organic all-purpose flour
1 yolk made from the composition presented in Table 8
1 tbsp organic cane sugar
1 tbsp cold vegan butter
3 tbsp cold water

### Ingredients for the Filling

4 yolks made from the composition presented in Table 8
1+⅓ cup of coconut milk
2 tsp cornstarch
¼ cup of raw sugar
½ tsp agar agar powder

### Method

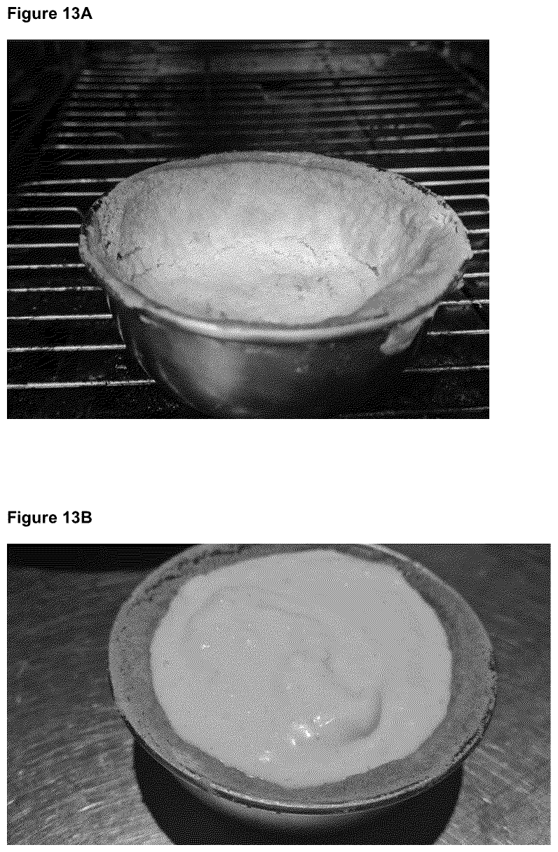

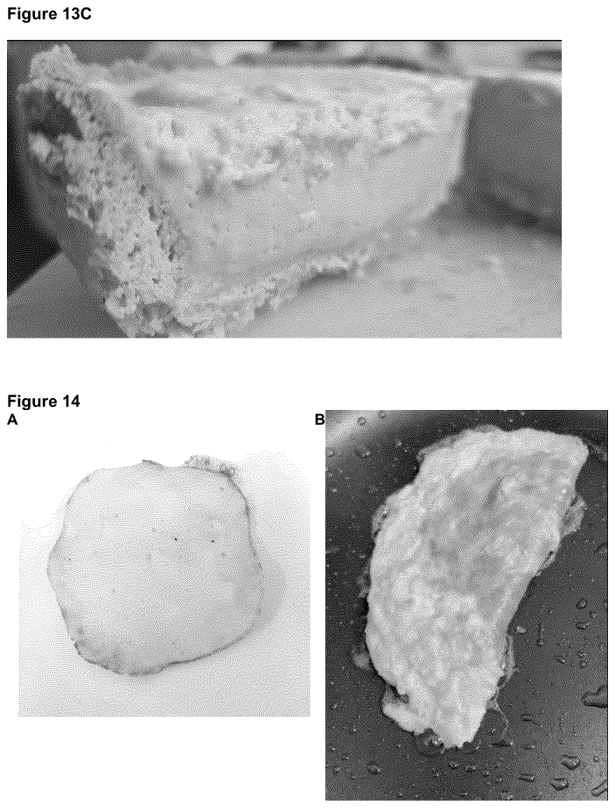

Prepare the butter dough. Add the flour, butter and salt to a bowl. Combine and knead the dough until smooth. Form into a flattened disc. Cover with plastic wrap and refrigerate for 20 minutes.
Prepare the water dough. Add the flour, yolk, sugar, butter, and water to a bowl and combine.
Knead the dough until smooth. Add 1 tsp of water at a time if the dough is too dry. Form into a flattened disc. Cover with plastic and refrigerate for 20 minutes.
After 20 minutes, remove both doughs from the refrigerator. Flour a clean, dry surface. Place the butter dough on the surface first. Top with the water dough. Flour your rolling pin and roll the dough into a rectangular shape.
Using a scraper, fold the dough into thirds. Roll the dough into a rectangular shape again. Fold the dough into thirds three more times. After the last roll, cover the dough and refrigerate again for 30 minutes.
Preheat the oven to 170° C.
After 30 minutes, roll the dough out until about ⅓ cm thick. Using a round cookie cutter about the size of your tart pans (about 2 inches wide, any small tart pans can be used). Cut the dough and press them into the tart pans, making sure all the sides of the tart pans are evenly coated with the dough. Repeat until all the dough is used up. Add the finished tart pans onto a baking sheet pan.
Bake the tarts for 18-20 minutes. Meanwhile, prepare the filling.
Combine all the ingredients for the filling to a saucepan. Whisk the filling until all the ingredients are smooth and well-combined. Heat the saucepan over medium heat. Continue to stir until the filling starts to thicken. Turn off heat.
Once the tarts finish baking, allow them to cool for 10 minutes. Pour the filling into the tart pans. Carefully transfer the tarts to a refrigerator and allow the filling to set for about 1 hour before serving. FIGS. 13A-13C show a custard tart prepared with Vegan yolks.

### Example 7: Vegan Egg White

According to an embodiment of the invention, the plant-based vegan egg white composition comprises the following components: Tofu, rice flour, black salt, coconut or other plant-based cream, tapioca starch and cornstarch. To achieve a fully functional egg white substitute that more closely mimics the properties of a chicken egg, a flavour masking agent may be added to mask undesirable “beany” taste from the plant-based ingredients. The masking agent preferably comprises maltodextrin, a flavouring that enhances “creaminess” and “mouthfulness”, yeast extract and salt. A commercially available example of such a masking agent is marketed as a part of the “KOKUMI” type flavour by Ajinomoto.

### 7.1 Components

Tofu is cholesterol free, low in saturated fat, and high in protein. On a moisture-free basis, tofu contains about 50% protein and 27% fat, most of which is polyunsaturated fatty acids. Tofu is also a good source of calcium. In some cases, the plant-based protein used in a plant-based egg white formulation can range into the various types and hardness of tofu. It can also be found in soy yoghurt. It is found that silken tofu is the optimum ingredient for this formulation as it allows for a smooth texture reminiscent of avian eggs. Hard tofu may also be used, though it falls short on various parameters. For instance, hard tofu tends to leave a certain residue which does not resemble the mouthfeel of avian egg whites when used in this formulation.

Rice flour is a thickening agent for the formulation of the plant-based white. Rice flour gives an omelette a white appearance, prevents liquid separation, and increases the viscosity and elasticity of the plant-based white egg mixture which gives it a similar texture to a chicken egg white. Preferably, white rice flour is used as it contributes to the natural colour of the egg white. In some cases, rice flour may be substituted in the formulation with flours of other origins, which can include wheat, chickpea, buckwheat, corn, potato and spelt. However, rice flour, being inherently white, allows the vegan simulated egg white to remain white as well, to match the fluorescent white colour of a typical fried avian egg white. Its ability to prevent liquid separation also allows for a viscosity, mouthfeel and stretch that is reminiscent of fried avian egg whites

Coconut cream is a source of medium-chain triglycerides (MCT). It lowers the bad cholesterol and increases the good cholesterol, and acts as a good fat substitute to mimic one found in whole chicken eggs. It is also a rich source of B vitamins, vitamin C, vitamin E as well as a source of essential minerals including magnesium and phosphorus. In some cases, coconut cream may be substituted in the vegan simulated egg white formulation with other plant-based creams that may include rice, oat, cashew and almond cream. Plant-based milks may also be used in lower amounts in the formulation to ensure that the formulation is not too runny. Such milks may include soy, oat, almond, cashew, rice, hemp, pea or peanut milk.

Black Salt, also known as kala namak, or Himalayan black salt, was chosen for the composition of the plant-based egg white. Black salt consists primarily of sodium chloride and traces of sodium bisulfite and hydrogen sulfide. The sulfur compounds provide black salt its distinctive taste and smell, with hydrogen sulfide being the most prominent contributor, imitating the sulfurous aroma and smell of a whole chicken egg. In some cases, other forms of salt may be substituted in the vegan simulated egg white formulation. Such salts may include sea salt, himalayan pink salt, kosher salt or regular table salt. While such substitutions may work to simulate the viscosity, colour and mouthfeel of an avian egg white, black salt is found to be the optimum across all parameters as it provides a sulfuric taste that is reminiscent of avian egg whites.

Tapioca Starch is a food thickener and stabilizer. Tapioca Starch is used to improve the taste and texture of the egg, and to give consistency or stickiness to the texture. In some cases, other forms of starch may be used in the formulation. For instance, corn starch could be used in higher amounts. Other starches like potato and arrowroot could also be used as a substitution. Such starches and compositions would not provide the vegan simulated egg white with certain elements that the tapioca starch provides. Such elements include the fact that tapioca starch adds to the binding properties of the other ingredients used for the composition. The element of colour is also optimised towards that of an avian egg when tapioca starch is used, as it provides more of a glossy finish.

Corn Starch is a tasteless thickening agent that does not interfere with the taste profile of the overall composition. Much like the tapioca starch used in the formulation, corn starch may be substituted with other starches including potato and arrowroot to create the plant-based egg white. That being said, cornstarch has a binding property that allows it to complement the other ingredients in ensuring the texture of the vegan simulated egg white is very similar to that of an avian fried egg white.

Gellan gum is a food additive used to bind, stabilize, or texturize processed foods to confer strength and stretch of the plant-based vegan simulated egg whites to match that of a chicken egg. Preferably, native high acyl gellan gum is used because it recreates the springiness and slight elastic characteristic associated with cooked egg white. Alternatives include guar gum and xanthan gum. High acyl gellan gum is preferred because it provides better moisture retention, flavor release and storage stability.

In some embodiments of the invention, the relative amounts of the vegan egg white composition components are as shown in Table 9.

TABLE 9
Components for egg white composition

| | | |
|---|---|---|
| 225 | g | silken tofu |
| 25 | g | rice flour |
| 48 | ml | Filtered water, cold |
| 2 | g | Kala Namak (Black salt) |
| 30 | g | Kara Coconut cream |
| 8 | ml | Filtered water |
| 4.5 | g | tapioca starch |
| 4 | g | corn starch |

In some embodiments, the vegan egg white composition further comprises a gum and the relative amounts of the components are as shown in Table 10.

TABLE 10
Components for egg white composition

| Composition wt % | Ingredient |
|---|---|
| 60-75 | tofu |
| 5-10 | rice flour |
| 15-20 | water |
| 0.5-2 | Kala Namak (Black salt) |
| 5-10 | Coconut cream |
| 0.5-3 | tapioca starch |
| 0.5-3 | corn starch |
| 0.5-1.5 | gum |

Preferably the gum is selected from xanthan gum, guar gum and gellan gum, more preferably high acyl gellan gum. In some embodiments, the egg white composition further comprises a flavour masker to further improve the flavour similarity with a natural egg white. The masking agent preferably comprises maltodextrin, flavouring that enhances “creaminess” and “mouthfulness”, yeast extract and salt. A commercially available example of such a masking agent is marketed as a part of the “KOKUMI” type flavour by Ajinomoto.

### 7.2 Method of Preparation

i) in a blender, combine the tofu, rice flour, water, kala namak, plant-based cream, tapioca starch, corn starch and gum;
ii) blend the combination for about 30 sec, or until completely smooth;
iii) pulse the mixture for about 10 sec, wherein the blending is performed at about 22-24° C.

### i) Egg White Omelette

The vegan simulated egg white may be used in various fried cooking methods, similar to an avian egg white. In this particular case, the vegan egg white was cooked and browned on both sides to directly replicate the method of preparation of an avian egg white omelette. As can be seen in FIGS. 14A and B, the omelette has achieved a good level of browning on either side to simulate real chicken eggs. We also observe that the egg white is very closely comparable to a chicken egg white omelette in terms of the stretch that is achieved, as well as the bounciness and fluffiness of the final formulation, after it is cooked. Also notable is the fact that the colour of the egg white omelette matches that of an avian egg white omelette.

### ii) Egg Drop Soup

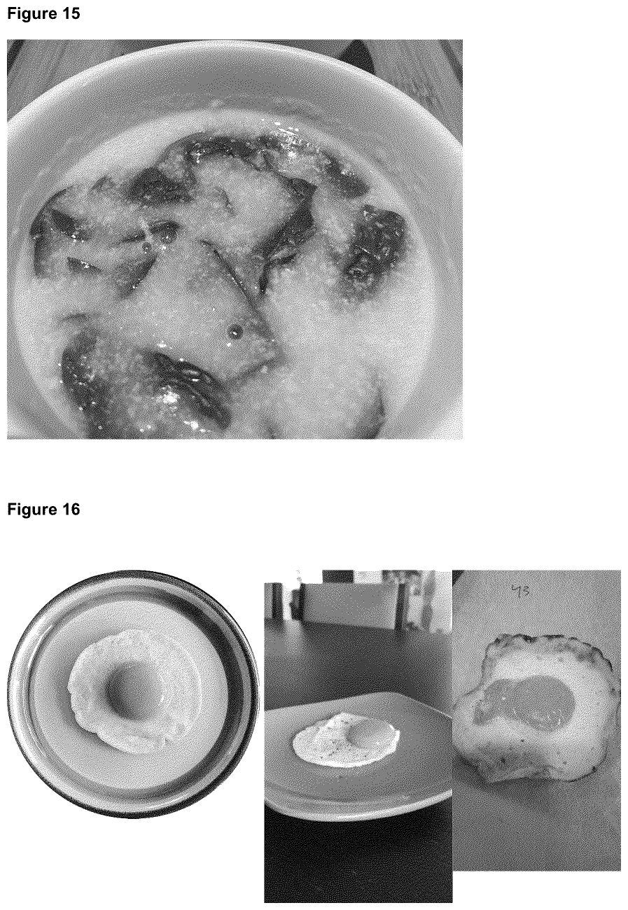

The vegan simulated egg white may be used in an egg drop soup as a substitute to chicken egg white. FIG. 15 shows a vegan egg drop soup prepared with the vegan egg white. In some embodiments of the invention, the relative amounts of the vegan egg white composition components are as shown in Table 11.

TABLE 11

| Composition wt % | Ingredient |
|---|---|
| 66.8 | tofu |
| 7.2 | rice flour |
| 15.6 | water |
| 0.9 | Kala Namak (Black salt) |
| 7.3 | Coconut cream |
| 0.53 | tapioca starch |
| 0.65 | corn starch |
| 0.74 | gum |

### Example 8: Vegan Egg White with Increased Protein

In order to enhance the nutritional value of the vegan egg white, the protein content was increased. Increasing the protein content can be a challenge to avoid detrimental effects on the organoleptic qualities of the vegan egg white. Plant-based protein could be sourced from fava bean, mung bean, soy, pea, chickpea, potato, oat, wheat, lentil, lupin, navy bean, peanut, sunflower, almond, corn, canola, quinoa, rice or sorghum.

Fava bean was found to be most ideal because of its clean taste. Fava bean protein powder is extracted from fava beans, also known as faba or broad beans. The protein is gluten free. In order to incorporate the fava bean protein in the vegan egg white, the composition described in Table 10 was modified by removing the corn starch and the tapioca starch and adjusting the amounts of other components.

In some embodiments, the vegan egg white composition comprises fava bean protein and the relative amounts of the components are as shown in Table 12.

TABLE 12
Components for enhanced protein egg white composition

| Composition wt % | Ingredient |
|---|---|
| 60-80 | tofu |
| 0.1-2 | rice flour |
| 15-25 | water |
| 0.1-2 | Kala Namak (Black salt) |
| 2-5 | Coconut cream |
| 2-10 | Fava bean protein |
| 0.5-1.5 | gum |

This egg white can be used in sunny side up or egg white omelette applications. A flavour masking agent may be used as the amount of fava bean protein is increased.

An example of an egg white composition comprising overall 10 wt % of protein, which is close to the protein content of a chicken egg white of about 10 wt %, comprises; fava bean protein in an amount of about 7.0%, tofu in an amount of 71.9%, water in an amount of 15.8%, coconut cream in an amount of 3.0%, rice flour in an amount of 0.5%, black salt in an amount of about 0.2%, gum in an amount of 0.8% and flavour masking agent in an amount of 0.8%, by weight of said egg white composition.

### Example 9: Preparation of Vegan Fried Egg

A vegan fried egg of the invention may be produced using the vegan egg yolk and the vegan egg white compositions. In some embodiments, a suitable method of preparation is as follows:
1. Heat a small pan until smoky hot, then add 1 teaspoon of canola oil before pouring in a desired amount of the egg white composition of Example 6 or Example 8.
2. After 2 minutes, add the egg yolk composition from Example 1 onto the egg white for another 2.5 minutes until it is fried.
   Example images of plant-based fried egg are shown in FIG. 16. The average weight of the plant-based fried egg (egg yolk+egg white) was 43 g, compared to an average fried chicken egg of 44 g.

### Example 10: Preparation of Vegan Poached Egg

To prepare a plant-based poached egg, the egg white composition of Example 6 is undercooked, so it has a less firm and more runny appearance than a fried egg white, and then the egg yolk composition of Example 1 is added.

### REFERENCES

Lin Lin, Hanja Allemekinders, Angela Dansby, Lisa Campbell, Shaunda Durance-Tod, Alvin Berger, Peter J H Jones, Evidence of health benefits of canola oil, Nutrition Reviews, 71 (6): 370-385 (2013).
U.S. Pat. No. 7,186,807; Salome, Jean-Paul et al., “Process for extracting the components of pea flour” (2003).
WO 2011/065880 A1; SWEDISH OAT FIBER AB. “Dietary fibre composition containing β-glucan”.

1. A plant-based vegan simulated egg yolk composition comprising the components:
tomatoes or natural orange color such as beta-carotene, canola oil, calcium lactate, chickpeas, turmeric, miso; and
a) beta-glucan from a grain bran or oat fibre, plant-based emulsifier, natural flavoring and a gum; or
b) kala namak, aquafaba, mustard, paprika and chilli powder; or
c) kala namak, aquafaba, mustard and a gum,
wherein the egg yolk has been encapsulated in sodium alginate by reverse-spherification.

2. The plant-based vegan simulated egg yolk composition of claim 1, wherein in a) the beta-glucan is from oat fibre or barley.

3. The plant-based vegan simulated egg yolk composition of claim 1, comprising:
tomatoes in an amount of about 25-35 wt %, canola oil in an amount of about 15-30 wt %, calcium lactate in an amount of about 0.5-3 wt %, chickpeas in an amount of about 5-15 wt %, turmeric in an amount of about 0.1-2 wt %, miso paste in an amount of about 2-7 wt %; and
a) oat bran powder in an amount of about 1-5 wt %, soy lecithin in an amount of about 0.5-1 wt %, natural flavoring in an amount of about 1-3 wt % and gellan gum in an amount of about 0.05-0.1 wt %; or
b) kala namak in an amount of about 0.5-2.0 wt %, aquafaba in an amount of about 20-30 wt %, mustard in an amount of about 1-5 wt %, paprika in an amount of about 0.4-0.6 wt % and chilli powder in an amount of about 0.1-0.2 wt %; or
c) kala namak in an amount of about 0.5-2.0 wt %, aquafaba in an amount of about 20-30 wt %, mustard in an amount of about 1-5 wt % and xanthan gum in an amount of about 0.05-2 wt %,
by weight of said egg yolk composition.

4. The plant-based vegan simulated egg yolk composition of claim 1, comprising:
a) tomatoes in an amount of about 25-30 wt %, canola oil in an amount of about 15-20 wt %, calcium lactate in an amount of about 1-3 wt %, chickpeas in an amount of about 10-15 wt %, turmeric in an amount of about 0.1-0.5 wt %, miso paste in an amount of about 5-7 wt %, oat bran powder in an amount of about 1-5 wt %, soy lecithin in an amount of about 0.5-1 wt %, natural flavoring in an amount of about 1-3 wt %, and gellan gum in an amount of about 0.05-0.1 wt %; or
b) tomatoes in an amount of about 25-35 wt %, canola oil in an amount of about 20-30 wt %, calcium lactate in an amount of about 0.5-2 wt %, chickpeas in an amount of about 5-10 wt %, turmeric in an amount of about 0.1-2 wt %, miso paste in an amount of about 2-5 wt %, kala namak in an amount of about 0.5-2.0 wt %, aquafaba in an amount of about 20-30 wt %, mustard in an amount of about 1-5 wt %, paprika in an amount of about 0.4-0.6 wt %, and chilli powder in an amount of about 0.1-0.2 wt %; or
c) tomatoes in an amount of about 25-35 wt %, canola oil in an amount of about 20-30 wt %, calcium lactate in an amount of about 0.5-2 wt %, chickpeas in an amount of about 5-10 wt %, turmeric in an amount of about 0.1-2 wt %, miso paste in an amount of about 2-5 wt %, kala namak in an amount of about 0.5-2.0 wt %, aquafaba in an amount of about 20-30 wt %, mustard in an amount of about 1-5 wt %, and xanthan gum in an amount of about 0.05-2 wt %,
by weight of said egg yolk composition.

5. The plant-based vegan simulated egg yolk composition of claim 1, wherein in a) the natural flavoring is black salt and/or nutritional yeast; or wherein in b) or c) the mustard is selected from the group comprising Dijon mustard, English mustard and whole grain mustard.

6. The plant-based vegan simulated egg yolk composition of claim 1, wherein in b) or c) the canola oil is substituted in whole or in part by another plant oil, such as rapeseed oil, peanut oil, vegetable oil, soya bean oil.

7. The plant-based vegan simulated egg yolk composition of claim 6, wherein 10 wt % to 90 wt %, preferably 20 wt % to 60 wt %, of the canola oil is substituted by a rapeseed oil containing phytosterols, such as Vividol® T oil or Akoplanet RSO 100-17100-17.

8. (canceled)

9. The plant-based vegan simulated egg yolk composition of claim 1, further comprising one or more coloring agents.

10. The plant-based vegan simulated egg yolk composition of claim 1, wherein in c) the composition comprises:
tomatoes in an amount of about 29.4 wt %, canola oil in an amount of about 24.8 wt %, Vividol-T oil in an amount of about 6.2 wt %, kala namak in an amount of about 1 wt %, calcium lactate in an amount of about 1 wt %, aquafaba in an amount of about 23.7 wt %, chickpeas in an amount of about 7 wt %, mustard in an amount of about 2 wt %, turmeric in an amount of about 0.5 wt %, miso paste in an amount of about 4.2 wt %, gum in an amount of about 0.1 wt % and natural orange colouring agent, such as apocarotenal, in an amount of about 0.2 wt %, by weight of said egg yolk composition.

11. A method for producing a vegan simulated egg yolk composition of claim 1, comprising the steps:
i) combine, until well-mixed, water and sodium alginate to form a 0.7% (7 g/L) alginate solution and refrigerate;
ii) combine, until well-mixed, the components defined in claim 1, except calcium lactate, and remove fine particles with a fine mesh sieve;
iii) combine, until well-mixed, calcium lactate and the mixture of ii);
iv) refrigerate the mixture of iii) in portions in moulds for about 15 min;
v) place the moulds in a freezer for about 50-60 min;
vi) encase the portions of v) in the sodium alginate mixture i) by reverse spherification to form simulated egg yolks.

12. A plant-based vegan simulated egg yolk composition produced by the method of claim 11.

13. A plant-based vegan simulated egg white composition having the sensory properties of an avian egg white, comprising the components:
tofu, flour, water, kala namak, a plant-based cream, a gum selected from the group of elastic gel-forming gums, preferably high acyl gellan gum; and
a) fava bean protein; or
b) tapioca starch and corn starch.

14. The plant-based vegan simulated egg white composition of claim 13, comprising:
a) tofu in an amount of about 60-80 wt %, rice flour in an amount of about 0.1-2 wt %, water in an amount of about 15-20 wt %, kala namak in an amount of about 0.1-2 wt %, plant-based cream in an amount of about 2-5 wt %, fava bean protein in an amount of about 2-10 wt % and gum in an amount of about 0.5-1.5 wt %; or
b) tofu in an amount of about 60-75 wt %, rice flour in an amount of about 5-10 wt %, water in an amount of about 15-20 wt %, kala namak in an amount of about 0.5-2 wt %, plant-based cream in an amount of about 5-10 wt %, tapioca starch in an amount of about 0.5-3 wt %, corn starch in an amount of about 0.5-3 wt % and gum in an amount of about 0.5-1.5 wt %,
by weight of said egg white composition; and/or
wherein the tofu is silken tofu; and/or the plant-based cream is selected from coconut, rice, oat, cashew and almond cream.

15. The plant-based vegan simulated egg white composition of claim 13, further comprising a flavour masking agent.

16. (canceled)

17. The plant-based vegan simulated egg white composition of claim 15, comprising:
a) fava bean protein in an amount of about 7%, tofu in an amount of 71.9%, water in an amount of 15.8%, coconut cream in an amount of 3%, rice flour in an amount of 0.5%, black salt in an amount of about 0.2%, gum in an amount of 0.8% and a flavour masking agent in an amount of 0.8%, by weight of said egg white composition; or
b) tofu in an amount of about 66.8 wt %, rice flour in an amount of about 7.2 wt %, water in an amount of about 15.6 wt %, kala namak in an amount of about 0.9 wt %, coconut cream in an amount of about 7.3 wt %, tapioca starch in an amount of about 0.53 wt %, corn starch in an amount of about 0.65 wt % and high acyl gellan gum in an amount of about 0.74 wt %,
by weight of said egg white composition.

18. A method for producing a vegan simulated egg white composition of claim 13, comprising the steps:
i) in a blender, combine the components of a) or b);
ii) blend the combination for about 30 sec, or until completely smooth;
iii) pulse the mixture for about 10 sec, wherein the blending is performed at about 22-24° C.

19. A plant-based vegan simulated egg white composition produced by the method of claim 18.

20. A plant-based vegan simulated fried egg composition comprising:
a vegan simulated egg yolk composition having the sensory properties of an avian egg yolk; and
a vegan simulated egg white composition having the sensory properties of an avian egg white, wherein
a) the egg yolk composition comprises the components defined in claim 1; and
b) the egg white composition comprises the components defined in claim 13; and/or
wherein the egg yolk has been encapsulated by reverse-spherification, preferably using 7 g/L sodium alginate.

21. (canceled)

22. A method of preparing the plant-based vegan simulated fried egg, comprising heating the plant-based vegan simulated egg white composition of claim 13 in a pan until it simulates a fried egg white; then associating the plant-based vegan simulated egg yolk of claim 1 with the fried egg white to resemble a fried egg.

23. A kit or combination comprising:
i) a plant-based vegan simulated egg yolk composition of claim 1 and a plant-based vegan simulated egg white of claim 13,
wherein said egg white and said egg yolk are separated in a container by one or more barriers; or
ii) a plant-based vegan simulated egg yolk composition of claim 1; or
iii) a plant-based vegan simulated egg white of claim 13.

24. The kit or package of claim 23, wherein in (i) said egg white and said egg yolk are separated in the container by a single barrier; and/or wherein in (ii) the egg yolk is packaged within a covering layer of vegetable oil to sustain the shape of the yolk.

25. (canceled)
